(19) United States
(12) Patent Application Publication
(10) Pub. No.: US 2018/0112593 A1
(43) Pub. Date: Apr. 26, 2018

(54) ACTUATOR

(71) Applicant: Hanon Systems, Daejeon (KR)

(72) Inventors: Roman Lehnert, Ittlingen (DE); Manuel Schieker, Mannheim (DE); Christoph Thiery, Mannheim (DE)

(21) Appl. No.: 15/784,256

(22) Filed: Oct. 16, 2017

(30) Foreign Application Priority Data
Oct. 21, 2016 (DE) 102016220780.6

(51) Int. Cl. F02B 37/18; F16K 31/04

(52) U.S. Cl. CPC F02B 37/186; F16K 31/047

(57) ABSTRACT

The invention pertains to an actuator for actuating a valve, the valve featuring a drive and at least one rotational threaded element with a first and a second threading segment and a third threading segment positioned between them. The actuator further features a drive element that is translationally driven by the threaded element. The actuator according to the invention is characterized in that the pitch angle in the third threading segment is greater than the pitch angle in the first and second threading segment.

### CROSS REFERENCE TO RELATED PATENT APPLICATION

This patent application claims priority to German Patent Application No. 10 2016 220 780.6 filed Oct. 21, 2016, the entire disclosure of which is hereby incorporated herein by reference.

### FIELD OF THE INVENTION

The invention pertains to an actuator and a combination of an actuator with a valve element, as well as an exhaust gas recirculation valve, a waste gate, and variable turbine geometry of an exhaust gas turbo charger.

### BACKGROUND OF THE INVENTION

Devices of the aforementioned type are commonly used in combustion engines where, depending on their operating status, exhaust gas must be supplied to the fresh air side in order to reduce fuel consumption and pollutant emissions. A translationally movable valve tappet can be actuated by means of the actuator over a corresponding valve.

It is known from EP 2 418 373 A1 that the rotational threaded element over which the valve is translationally moved features at least two segments with different thread pitches.

Such actuators have proven themselves. However, they are faced with ever increasing requirements.

### SUMMARY OF THE INVENTION

The task of the present invention is to improve an actuator with a simple construction.

This task is solved according to the invention by the actuator disclosed herein. The actuator is characterized in that it features a threaded element with a first and a second threading segment, as well as a third threading segment positioned between them, wherein the pitch angle or the increase, respectively, in the third threading segment is greater than the pitch angle or the increase, respectively, in the first and second threading segment. In other words: the thread in the third threading segment is steeper than in the first and second threading segment.

Underlying the invention is the idea of providing an actuator for a valve in which the translational movement of the drive element when the third threading segment is engaged is greater than when the first or the second threading segment is engaged.

This makes it possible to specifically adjust the transmission capacity depending on the respective threading segment, in the sense that the transmission capacity in the first and second threading segment is greater, while in the third threading segment lying in between them it is smaller. This allows for the exploitation of the flexibility in terms of capacity and trajectory. In this manner, the translational movement of the drive element can be advantageously utilized for a valve.

This allow for achieving at least one of the following advantages:

Due to the more moderate increase in the first and second threading segment, a greater opening force can be transmitted, which correlates with a longer rotational trajectory. As a result, a comparatively stronger force may be used, for instance at the beginning of the opening or closing movement of the valve, in order to perform the movement. Due to the fact that the pitch angle in the first and second threading segment is smaller than the increase in the third threading segment, a smaller electric motor can be used as a power source, since the higher application of force can be obtained over the moderate increase. The result is, for instance, that a smaller electrical drive can be built in.

A further point is that when a lower drive performance should suffice, this drive is also less energy-intensive, which leads to an overall lower energy consumption. This is particularly noticeable, because force must continuously, that is: constantly, be exerted in an opening position as well as in a closing position of the valve. A higher actuation force may therefore be achieved in both end positions of the valve at a low energy supply.

Furthermore, the higher increase in the third threading segment allows for faster adjustments of a valve in the interim section. This increases the response time, or respectively, the changeover time within the valve can be switched.

An additional point is that when using the valve, it is important in practice that the valve is not unintentionally switched by other forces. Specifically, a gas exerts gas forces. Due to the fact that the increase in the first and second threading segment is higher, it is possible to generate a correspondingly high counterforce in these sections, which makes it less likely for gas forces to change the position of the valve.

The invention further pertains to a combination of an actuator according to the invention with a valve element. The invention further pertains to an exhaust gas recirculation valve, a waste gate or a variable turbine geometry of an exhaust gas turbo charger with the actuator according to the invention.

Further advantageous embodiments of the invention are described herein.

Further characteristics and advantages of the invention will become clear from the detailed description below.

### DESCRIPTION OF THE DRAWINGS

FIG. 1 shows a cross-sectional top perspective view of an actuator according to the invention;

FIG. 2 schematically shows a pitch angle of a threaded element of the actuator according to the invention; and

FIG. 3 shows a cross-sectional front perspective view of the actuator according to the invention.

### DETAILED DESCRIPTION OF AN EMBODIMENT

An embodiment of the present invention is described below in detail with reference to the figures.

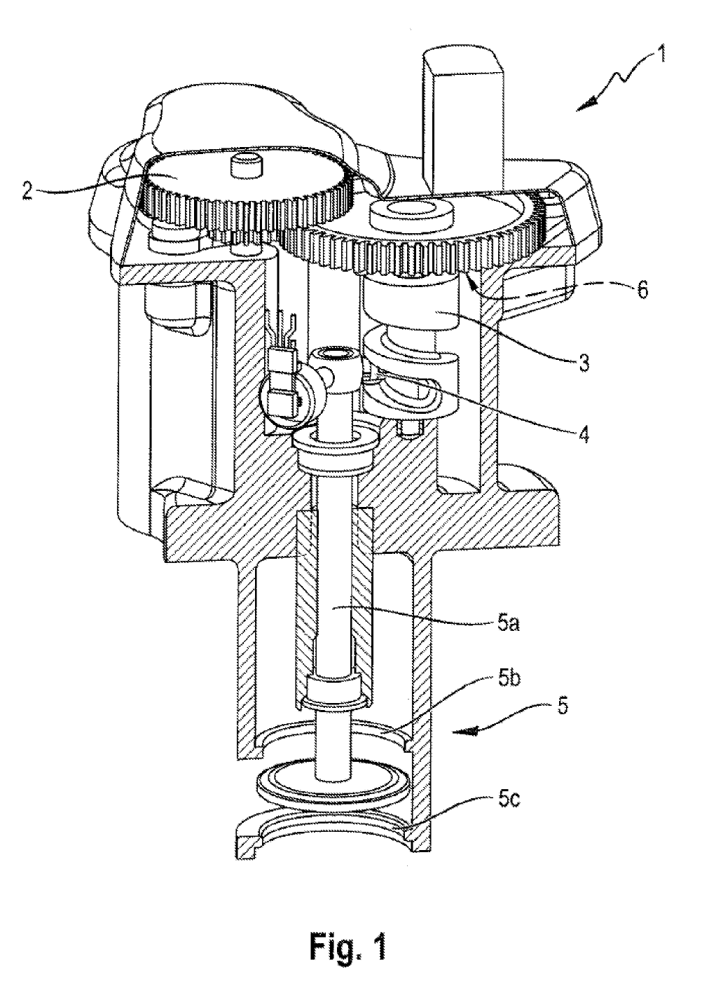

FIG. 1 shows the actuator 1 with a drive 2, which features two cogwheels. The drive 2 of the actuator 1 shown is a rotary drive. The rotational threaded element 3 might be a screw with threading or with partial threading. The screw is one of the type also called “worm”. The threaded element 3 is engaged by the translationally driven drive element 4 in such a manner that a rotation of the threaded element 3 leads to a translational movement of the drive element 4. The drive element 4 may, for instance, be a segment protruding from the valve tappet 5a, a wheel, a roll, or another element. The rotational movement of the rotational drive is therefore converted into a lifting movement of the valve tappet 5a. The valve element 5 is connected with the actuator 1 or with the drive element 4, respectively, by means of the valve tappet 5a.

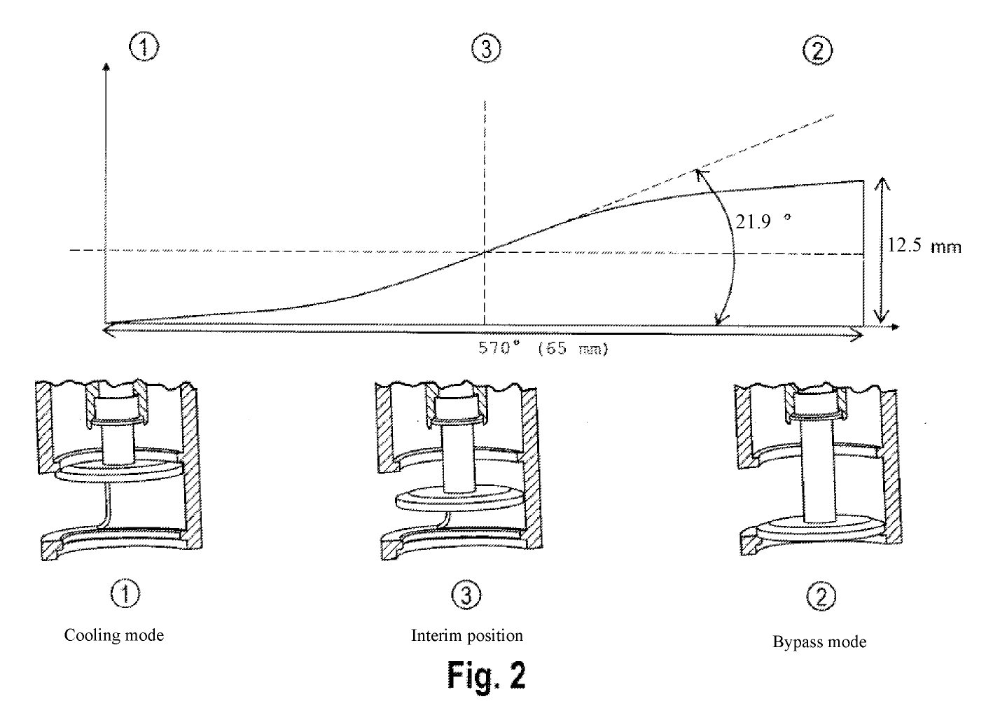

FIG. 2 shows the pitch angle of the threading segment of the threaded element 3, with the pitch angle marked (in degrees) as a function of the turning range (in degrees). FIG. 2 therefore reflects the increase of the threading.

The threaded element 3 features the first and second threading segment, which are marked in FIG. 2 as regions 1 and 2. Region 1 of the threading segment corresponds to the status of the valve in which the valve is adjacent to the upper valve seat 5b, whereas Region 2 corresponds to the status in which the valve is in the lower valve seat 5c. Region 3 corresponds to the interim position in the valve.

The first and second threading segment may each be at one end of the threaded element 3, in other words, the first threading segment at the upper end of the threaded element and the second threading segment at the lower end of the threaded element 3.

Preferentially, the first and second threading segments feature the smallest increase, that is, the smallest pitch angle of the threading. In these regions, a rotation of the threaded element generates a relatively small translational downward/downward movement of the drive element 4, that is, a relatively slow movement of the valve tappet 5a.

The third threading segment, which corresponds to Region 3 in FIG. 2, features the greatest increase. This leads to the situation that when the threaded element is turned, a rapid translational movement of the drive element 4 occurs in the interim position. In other words, the interim region can be traversed relatively quickly.

In the embodiment of FIG. 2, the third threading segment with the greatest increase is positioned equidistantly from the first threading segment and from the second threading segment.

When the first and second threading segments are each arranged at one end of the threaded element 3, the third threading segment is arranged in the middle of the threading.

As follows from FIG. 2, the increase, or respectively, the pitch angle preferentially increases monotonously from the first to the third threading segment, and decreases monotonously from the third to the second threading segment. A break in the progression of FIG. 2 should therefore be avoided. In other words, the transition from the first to the third and from the third to the second threading segment should be made gradually.

The increase, or respectively, the pitch angle between the first and the third threading segment and/or between the third and the second threading segment changes continuously over a turning range of at least 30°, and of at least 50°.

The total turning range of the threaded element amounts to between 400° and 700°, and more specifically, between 500° and 600°. In the embodiment shown in FIG. 2, the total turning range amounts to 570° (at a length of approx. 65 mm).

The pitch angle in the first and/or second threading segment should be within a range of 20 to 80, preferentially, within a range of 30 to 60, and further preferentially, within a range of 40 to 50. The pitch angle of the third threading segment is desired to be within a range of 19° to 25°, and more specifically within a range of 20° to 24°, and even more specifically within a range of 21° to 22°.

In the first, second, and third threading segment, the increase, or respectively, the pitch angle, is always consistent. In an embodiment, the increase, or respectively, the pitch angle in the first and second threading segment is identical.

The pitch angle in the first and/or the second threading segment is typically within a range of 2° to 8°, more specifically within a range of 3° to 6°, and even more specifically within a range of 4° to 5° . In the embodiment of FIG. 2, the pitch angle is 4.5°.

The pitch angle in the third threading segment is within a range of 19° to 25° , more specifically within a range of 20° to 24°, and even more specifically within a range of 21° to 22° . In the embodiment shown in FIG. 2, the pitch angle is 21.9°.

The third threading segment typically extends over a turning range of at least 45°, and more specifically of at least 90°. The turning range of the first and/or the second threading segment typically extends over a turning range of at least 70° and/or less than 120°, and more specifically over a turning range of 80° to 100°. In the embodiment shown in FIG. 2, the turning range of the first and of the second threading segment respectively extends over 90°.

In the embodiment shown in FIG. 2, the thread length, or respectively, the thread increase, amounts to a total of approx. 12.5 mm.

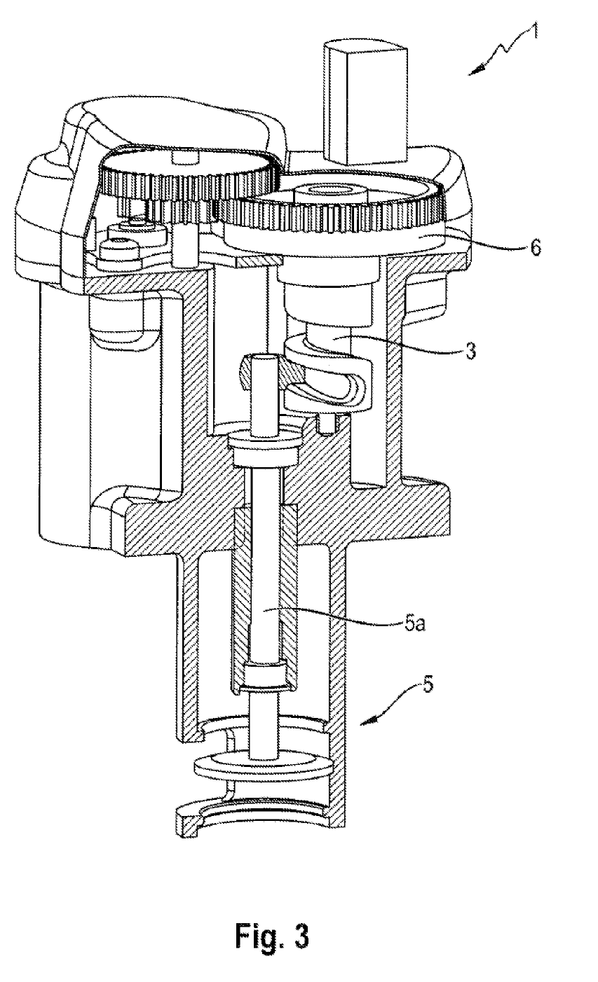

The actuator according to the invention may feature a spring element 6, which is arranged in the embodiment shown in FIG. 1 underneath the cogwheel, as indicated by the arrow 6. The spring element 6 is clearly visible in FIG. 3. This spring element 6 is designed to exert a preload on the threaded element such that the threaded element may engage with the drive element in the first threading segment in the event of a drive failure, for instance in the event of a power failure.

The spring element 6, which may, for instance, be a spiral spring, will then act as a fail-safe, even in the event of a failure or a power outage. This facilitates keeping the valve in cooling mode even in the absence of a power supply.

The actuator 1 according to the invention is advantageously combined with the valve element 5, the drive element 4 being directly or indirectly connected with the valve element 5. In the embodiment shown in FIG. 1, the drive element 4 is connected with the valve tappet 5a.

The combination of the actuator 3 and the valve element 5 is specifically arranged such that the drive element 4 engages the first or second threading segment of the threaded element 3 when the valve element 5 is in an end position, that is, in position 1 or 2 of FIG. 2, whereas the drive element 4 engages the third threading segment of the threaded element when the valve element 5 is in an interim position, as shown in Region 3 of FIG. 2.

The actuator 1 and the combination consisting of the actuator 1 and the valve element 5 are advantageously arranged in an exhaust gas recirculation valve, a waste gate, or a variable turbine geometry of an exhaust gas turbo charger.

The situation 1 in FIG. 2, in which the first threading segment is engaged, corresponds to the cooling mode; the situation 2 in FIG. 2, in which the second threading segment is engaged, corresponds to the bypass mode; the situation 3 in FIG. 2, in which the third threading segment is engaged, corresponds to the interim position.

### LIST OF REFERENCE NUMERALS

actuator 1

drive 2

threaded element 3

drive element 4

valve element 5

valve tappet 5a

upper valve seat 5b

lower valve seat 5c

spring element 6

What is claimed is:

1. An actuator for actuating a valve, the actuator comprising
a valve;
at least one rotational threaded element with a first threading segment and a second threading segment, and a third threading segment positioned between the first threading segment and the second threading segment; and
at least one drive element translationally driven by the threaded element, wherein a pitch angle in the third threading segment is greater than a pitch angle in the first threading segment and the second threading segment.

2. The actuator according to claim 1, wherein the first threading segment and the second threading segment are each arranged at ends of the threaded element.

3. The actuator according to claim 1, wherein at least one of the first threading segment and the second threading segment features a smallest pitch angle of threading.

4. The actuator according to claim 1, wherein the third threading segment features a greatest pitch angle of threading.

5. The actuator according to claim 1, wherein a pitch angle at least one of increases monotonously from the first threading segment to the third threading segment and decreases monotonously from the third threading segment to the second threading segment.

6. The actuator according claim 1, wherein a pitch angle in at least one of the first threading segment and the second threading segment is within a range of 2 to 8 degrees.

7. The actuator according to claim 1, wherein a pitch angle in the third threading segment is within a range of 19 to 25 degrees.

8. The actuator according to claim 7, wherein the pitch angle in the third threading segment is within a range of 20 to 24 degrees.

9. The actuator according to claim 1, wherein at least one of the first threading segment and the second threading segment extends over a turning range of at least 70 degrees and less than 120 degrees.

10. The actuator according to claim 9, wherein the at least one of the first threading segment and the second threading segment extends over the turning range of 80 to 100 degrees.

11. The actuator according to claim 1, wherein the third threading segment extends over a turning range of at least 45 degrees.

12. The actuator according to claim 11, wherein the third threading segment extends over the turning range of at least 90 degrees.

13. The actuator according to claim 1, wherein a pitch angle at least one of between the first threading segment and the third threading segment and between the third threading segment and the second threading segment changes continuously over a turning range of at least 30 degrees.

14. The actuator according to claim 13, wherein the pitch angle at least one of between the first threading segment and the third threading segment and between the third threading segment and the second threading segment changes continuously over the turning range of at least 50 degrees.

15. The actuator according to claim 1, wherein a total turning range of the threaded element is between 400 and 700 degrees.

16. The actuator according to claim 15, wherein the total turning range of the threaded element is between 500 and 600 degrees.

17. The actuator according to claim 1, wherein the actuator further comprises a spring element, wherein the spring element exerts a preload on the threaded element urging the threaded element to engage the drive element in the first threading segment.

18. The actuator according to claim 1, further comprising a valve element directly or indirectly connected with the drive element.

19. The actuator according to claim 18, wherein the drive element engages one of the first threading segment and the second threading segment of the threaded element when the valve element is approaching a closed position or an opened position, and wherein the drive element engages the third threading segment of the threaded element when the valve element is in an interim position.

20. The actuator according to claim 18, wherein the actuator is configured to be arranged in at least one of an exhaust gas recirculation valve, a waste gate, and a variable turbine geometry of an exhaust gas turbo charger.
